(19) United States
(12) Patent Application Publication
(10) Pub. No.: US 2026/0292300 A1
(43) Pub. Date: Sep. 24, 2026

(54) METHOD AND DEVICE FOR ENERGY REDUCTION ADJUSTMENT USING AN ADAPTIVE STREAMING NETWORK

(71) Applicant: InterDigital CE Patent Holdings, SAS, Paris (FR)

(72) Inventors: Franck AUMONT, VERN SUR SEICHE (FR); Claire-Helene DEMARTY, MONTREUIL LE GAST (FR); Olivier LE MEUR, TALENSAC (FR); Laurent BLONDE, THORIGNE-FOUILLARD (FR); Erik REINHARD, HEDE-BAZOUGES (FR)

(21) Appl. No.: 19/472,461

(22) PCT Filed: Mar. 26, 2024
(86) PCT No.: PCT/EP2024/058046

§ 371 Date: Oct. 3, 2025

(30) Foreign Application Priority Data
Apr. 3, 2023 (EP) 23305479.0
Jun. 16, 2023 (EP) 23305958.3
Nov. 10, 2023 (EP) 23306954.1

(51) Int. Cl. H04N 21/443; G06T 3/4007; H04N 21/84; H04N 21/845

(52) U.S. Cl. CPC H04N 21/4436; G06T 3/4007; H04N 21/84; H04N 21/8456

(57) ABSTRACT

A method and system are disclosed for reducing energy consumption during adaptive video streaming. A client device obtains, from a manifest file associated with a streaming session, information identifying one or more attenuation map representations. The information includes attributes such as a display model, a use type, and a combination type. An initialization segment of an attenuation map track is obtained, and at least one attenuation map representation is selected based on a target energy reduction rate. The client requests temporal segments of both the video representation and the selected attenuation map representation, decodes them, and combines the decoded attenuation map with the decoded picture according to the manifest-declared attributes to generate an attenuated picture. The attenuated picture is then provided to the display device. The application also encompasses a corresponding encoding method, a device configured to perform the method, and related computer program products.

### CROSS REFERENCE TO RELATED APPLICATIONS

This application claims the priority to European Application No. 23305479.0 filed 3 Apr. 2023, European Application No. 23305958.3 filed 16 Jun. 2023 and European Application No. 23306954.1 filed 10 Nov. 2023, which are incorporated herein by reference in their entirety.

### TECHNICAL FIELD

The disclosure is in the field of multimedia content distribution, and at least one embodiment relates more specifically to an adaptive video streaming system that allows to reduce the energy consumption by using an Attenuation Map.

### BACKGROUND ART

Reducing energy consumption of electronic devices has become a requirement not only for manufacturers of electronic devices but also to limit, as much as possible, the environmental impact and to contribute to the emergence of a sustainable display industry. The increase in display resolution from SD to HD, then to 4K and soon to 8K and beyond, as well as the introduction of high dynamic range imaging, has brought about a corresponding increase in energy requirements of display devices. This is not consistent with the global need to reduce energy consumption knowing that a huge number of devices has a display (i.e., TV, mobile phones, tablets, etc.). Indeed, displays are the most important source of energy consumption, for consumer electronic devices, either battery-powered (e.g., smartphones, tablets, head-mounted displays, car display screens) or not (e.g., television sets, advertisement display panels).

Different display technologies have been developed in the recent years. Although modern displays consume energy in a more controllable and efficient manner than older displays, they remain the most important source of energy consumption in a video chain.

As far as backlight displays are concerned, their energy consumption is largely determined by the intensity of the backlight.

Organic Light Emitting Diode (OLED) is one example of display technology that is finding increasingly widespread use because of numerous advantages compared to former technologies such as Thin-Film Transistor Liquid Crystal Displays (TFT-LCDs). Rather than using a uniform backlight, OLED displays, as well as mini LEDS, are composed of individual directly emissive image pixels. OLEDs power consumption is therefore highly correlated to the image content and the power consumption for a given input image can be estimated by considering the values of the displayed image pixels. Although OLED displays consume energy in a more controllable and efficient manner, they are still the most important source of energy consumption in the video chain.

It is therefore interesting to elaborate energy-aware images or videos, i.e., images or videos that will need less energy when displayed on display displays, notably on consumer electronics OLED displays. One technique is to generate energy-aware images from original images by using a dimming map with good properties such as a smoothness and a scalability. When used in a video coding chain, building energy-aware images may be implemented at different places in the chain: at the encoder, at the decoder, or at the display side. In addition, a signaling solution may allow to transmit the dimming maps and make them available for use at the display side of the chain. In such solution, a new SEI message may be created, and the dimming maps may be transmitted to the receiver device as auxiliary data.

ISO/IEC 23001-11 specifies metadata (Green Metadata) that facilitate reduction of energy usage during media consumption (i.e., decoding and display operation), and specifically for reducing display power consumption. The metadata for display adaptation are defined in section “Display power reduction using display adaptation”. They are particularly well tailored to non-emissive pixels display technology embedding backlight illumination such as LCD. They are designed to attain display energy reductions by using display adaptation techniques that generate dynamically, on the emitter side, RGB-component statistics and quality indicators metrics about the consumed video content. They can be used to perform RGB picture components rescaling to set the best compromise between backlight/voltage reduction and picture quality, reducing voltage, and therefore allowing to reduce the energy consumption. ISO/IEC 23001-11 (Annex B.3) specifies how to convey the display green metadata mentioned above in adaptive streaming as a MPEG-DASH representation which can be retrieved and used by the decoder to perform post-processing to all the available media representations and reduce energy consumption. However, it is far from being optimal, as these metadata convey global information and, in no case, convey information that would help the use of a pixel-wise Attenuation Map, as such a map is of no use for non-emissive pixel types of displays.

In terms of multimedia content distribution, adaptive streaming systems have become a major technology and propose techniques for content adaptation. MPEG-DASH is one example of adaptive streaming technology. The acronym refers to Dynamic Adaptive Streaming over HTTP and was developed by the Motion Picture Expert Group. MPEG-DASH is specified in ISO/IEC 23001 10, ISO/IEC 23009-1 and ISO/IEC 23009-3. This technology is hereunder simply referenced as DASH.

### SUMMARY

Embodiments described hereafter have been designed with the foregoing in mind and provide a mechanism for transmitting a pixel-wise Attenuation Map in an adaptive video streaming environment and allowing a receiver device to control its energy reduction rate when displaying the video. A new type of adaptation set for DASH, for example identified by @id=“ami”, standing for “Attenuation Map information” is inserted into a DASH MPD manifest file. In one embodiment, the MDP manifest file lists a set of pixel-wise attenuations maps available on the DASH server with associated parameters. In one embodiment, the MDP manifest file lists a set of tracks carrying attenuations maps and parameters for the attenuation maps are carried within a specific element of a track (for example using a file format box carried by initialization segments of the tracks). A DASH client can select one of the pixel-wise Attenuation Map representations based on different parameters comprising the associated energy reduction rates, the type of processing to use it, the type of display and combine this map with the received video.

A first aspect is directed to a decoding method comprising obtaining a manifest file representative of a visual content comprising information related to a video representation and to a set of Attenuation Map representations for the visual content, requesting segments of the video representation and requesting segments of an Attenuation Map representation selected based on a selected energy reduction rate, decoding picture from obtained segments of the video representation and decoding an Attenuation Map representation from obtained segments of the Attenuation Map representation, combining the decoded Attenuation Map representation with the decoded picture, and providing the attenuated picture for display.

A second aspect is directed to an encoding method comprising encoding a video from an obtained visual content, decoding the encoded video, for a target energy reduction rate, generating an Attenuation Map representation based on the decoded video, generating adaptation set information representative of parameters for the Attenuation Map representation, generating a manifest file representative of the obtained visual content comprising information related to the encoded video and to the adaptation set.

A third aspect is directed to a device comprising a processor configured to obtain a manifest file representative of a visual content comprising information related to a video representation and to a set of Attenuation Map representations for the visual content, request segments of the video representation and request segments of an Attenuation Map representation selected based on a selected energy reduction rate, decode picture from obtained segments of the video representation and decode an Attenuation Map representation from obtained segments of the Attenuation Map representation, combine the decoded Attenuation Map representation with the decoded picture, and provide the attenuated picture for display.

A fourth aspect is directed to a device comprising a processor configured to encode a video from an obtained visual content, decode the encoded video, for a target energy reduction rate, generate an Attenuation Map representation based on the decoded video, generate adaptation set information representative of parameters for the Attenuation Map representation, and generate a manifest file representative of the obtained visual content comprising information related to the encoded video and to the Attenuation Map representation.

A fifth aspect is directed to non-transitory computer readable medium containing comprising instructions which, when the program is executed by a computer, cause the computer to carry out the described embodiments related to the first aspect.

A sixth aspect is directed to a computer program comprising instructions which, when the program is executed by a computer, cause the computer to carry out any of the described embodiments or variants related to the first aspect.

The above presents a simplified summary of the subject matter in order to provide a basic understanding of aspects of the present disclosure. This summary is not an extensive overview of the subject matter. It is not intended to identify key/critical elements of the embodiments or to delineate the scope of the subject matter. Its sole purpose is to present concepts of the subject matter in a simplified form as a prelude to the more detailed description provided below.

### BRIEF SUMMARY OF THE DRAWINGS

The present disclosure may be better understood by consideration of the detailed description below in conjunction with the accompanying figures in which:

FIG. 1 illustrates a block diagram of an example of an environment comprising a display device in which various aspects and embodiments are implemented.

FIG. 2 illustrates an example of adaptive streaming system based on DASH.

FIG. 3 illustrates an example of Media Presentation Description based on DASH.

FIG. 4 illustrates an example of architecture for an energy-aware DASH server according to an embodiment.

FIG. 5 illustrates an example of architecture for an energy-aware DASH client according to an embodiment.

FIG. 6 illustrates an example of process for creating a DASH content comprising Attenuation Maps according to an embodiment.

FIG. 7 illustrates an example of process for using Attenuation Maps according to an embodiment.

It should be understood that the drawings are for purposes of illustrating examples of various aspects, features and embodiments in accordance with the present disclosure and are not necessarily the only possible configurations. Throughout the various figures, like reference designators refer to the same or similar features.

### DETAILED DESCRIPTION

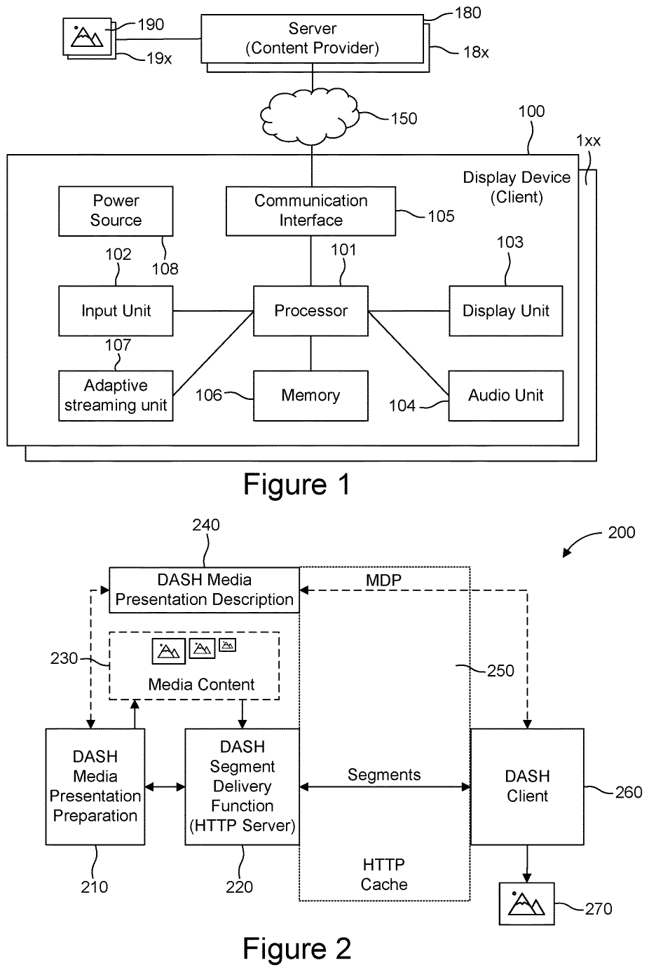

FIG. 1 illustrates a block diagram of an example of an environment comprising a display device in which various aspects and embodiments are implemented. In the depicted environment, a user interacts with the display device 100, for example a television, that is connected to a server 180 for example operated by a content provider. The server 180 delivers multimedia content 190 such as video streams based on images. In a video distribution system, multiple devices 100, 1xx are interacting with multiple content providers and corresponding servers 180, 18x delivering multiple multimedia content 190, 19x. A single content provider may use a plurality of servers. The devices exchange data through a communication network 150.

The communication network 150 preferably uses a communication standard to provide interoperability between content provider and display devices. Such communication standard may be wireless, such as cellular (e.g., LTE) communications, Wi-Fi communications, and the like, to ensure the mobility of the display device. Cable, satellite, or terrestrial digital television broadcast communication may also be used for the communication network 150 as well as broadband television communications. Such digital television standards may on based on well-established standards like DVB, ATSC, or the like. General purpose network standards may also be used, for example based on Ethernet.

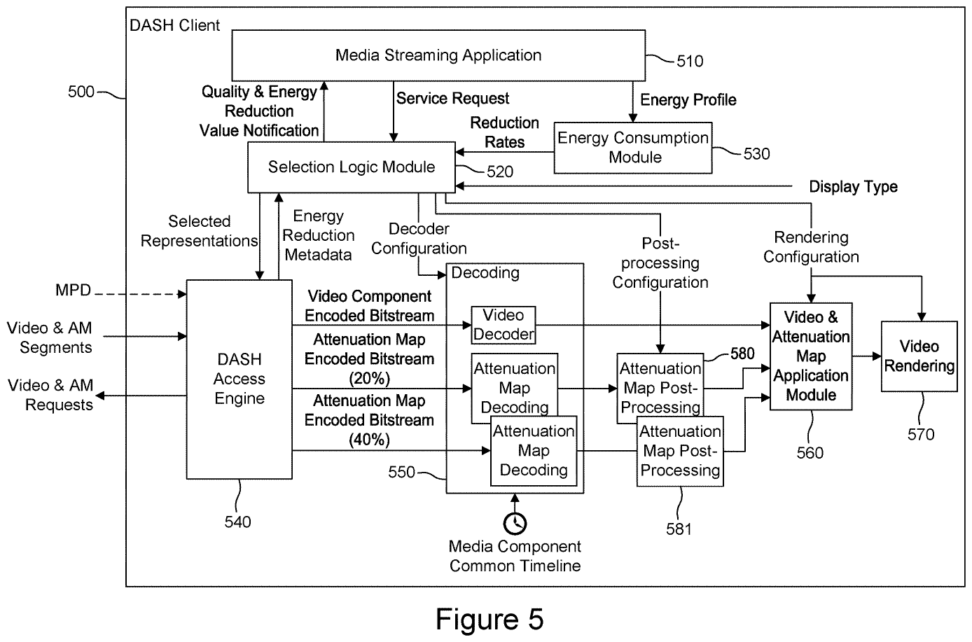

Communication is handled by an adaptive streaming unit 107 that provides the features conventionally needed to receive a content transported using adaptive streaming formats, such as DASH for example, comprising a streaming application, an access engine, a decoding module, orchestrated under control of a media timeline. According to embodiments, the adaptive streaming unit also comprises additional means to handle the Attenuation Map information, as described in the client architecture of FIG. 5 and provide the energy reduction capability not available in a conventional DASH client.

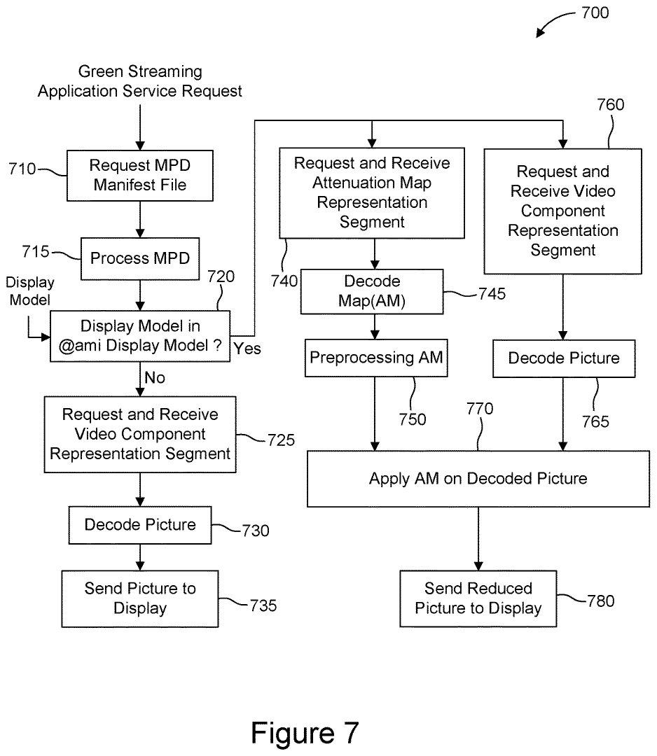

The display device 100 comprises a processor 101. The processor 101 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform data processing such as the decoding process 700 of FIG. 7.

The processor 101 may be coupled to an input unit 102 configured to convey user interactions. Multiple types of inputs and modalities can be used for that purpose. Physical keypad or a touch sensitive surface are typical examples of input adapted to this usage although voice control could also be used. In addition, the input unit may also comprise a digital camera able to capture still pictures or video in two dimensions or a more complex sensor able to determine the depth information in addition to the picture or video and thus able to capture a complete 3D representation.

The processor 101 may be coupled to a display unit 103 configured to output visual data to be displayed on a screen. Multiple types of displays can be used for that purpose such as a liquid crystal display (LCD) or organic light-emitting diode (OLED) display unit. The processor 101 may also be coupled to an audio unit 104 configured to render sound data to be converted into audio waves through an adapted transducer such as a loudspeaker for example.

The processor 101 may be coupled to a communication interface 105 configured to exchange data with external devices. The communication preferably uses a wireless communication standard to provide mobility of the display device, such as cellular (e.g., LTE) communications, Wi-Fi communications, and the like.

The processor 101 may access information from, and store data in, the memory 106, that may comprise multiple types of memory including random access memory (RAM), read-only memory (ROM), a hard disk, a subscriber identity module (SIM) card, a memory stick, a secure digital (SD) memory card, any other type of memory storage device. In embodiments, the processor 101 may access information from, and store data in, memory that is not physically located on the device, such as on a server, a home computer, or another device.

The processor 101 may receive power from the power source 108 and may be configured to distribute and/or control the power to the other components in the device 100. The power source may be any suitable device for powering the device. As examples, the power source may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While the figure depicts the processor 101 and the other elements 102 to 108 as separate components, it will be appreciated that these elements may be integrated together in an electronic package or chip. It will be appreciated that the display device 100 may include any sub-combination of the elements described herein while remaining consistent with the embodiments described hereafter. The processor 101 may further be coupled to other peripherals or units not depicted in FIG. 1 which may include one or more software and/or hardware modules that provide additional features, functionality and/or wired or wireless connectivity. For example, the peripherals may include a universal serial bus (USB) port, a vibration device, a television transceiver, a hands-free headset, a Bluetooth® module, a frequency modulated (FM) radio unit, a digital music player, a media player, a video game player module, an Internet browser, and the like. For example, the processor 101 may be coupled to a localization unit configured to localize the display device within its environment. The localization unit may integrate a GPS chipset providing longitude and latitude position regarding the current location of the display device but also other motion sensors such as an accelerometer and/or an e-compass that provide localization services.

In at least one embodiment, the processor 101 of the display device 100 is configured to display on the display unit 103 an image according to embodiments described further below. In a first variant embodiment, the image 190 is obtained from the content provider server 180 through the communication network 150. In a second variant embodiment, the image is obtained from the memory 106, stored for example after being captured by the input unit 102 or being transferred from a server.

Typical examples of device 100 are smartphones, tablets, laptops, monitors, head-mounted displays, television sets, video projectors, computer screens, vehicles (e.g., control and/or entertainment systems for cars, planes, boats, etc.), advertisement display panels, medical monitors, etc. However, any device or composition of devices that provides similar functionalities can be used as display device 100 while still conforming with the principles of the disclosure. In at least one embodiment, the device does not include a display unit but prepares data for display so that another device, such as a screen, can perform the display. Example of such devices are set top boxes, media players, desktop computers, encoders, decoders, servers, computing grids, cloud computers, etc.

At least one example of an embodiment can involve a device including an apparatus as described herein and at least one of (i) an antenna configured to receive a signal, the signal including data representative of the image information, (ii) a band limiter configured to limit the received signal to a band of frequencies that includes the data representative of the image information, and (iii) a display configured to display an image from the image information.

At least one example of an embodiment can involve a device as described herein, wherein the device comprises one of a television, a television signal receiver, a set-top box, a gateway device, a mobile device, a cell phone, a tablet, a computer, a laptop, or other electronic device.

FIG. 2 illustrates an example of adaptive streaming system based on DASH. The system 200 comprises a DASH server and a DASH client. The server is for example implemented through the content provider server 180 of FIG. 1 and the DASH client 260 is for example implemented using the display device 100 of FIG. 1. When a DASH client 260 wishes to play a multimedia content 270 in adaptive streaming, it first gets a Media Presentation Description (MPD), a.k.a a manifest, describing how this multimedia content might be obtained. This is generally done by getting the manifest from a URL (Uniform Resource Locator), for example through HTTP protocol as represented by the HTTP Cache 250 or by other means (e.g. broadcast, broadband service description, and so on). The manifest is generated in advance by the DASH media presentation description 240. The manifest may be static or may be updated dynamically. It lists the available representations, also called instances or versions 230, of the multimedia content, with variations in terms of coding bitrate, image resolution and other properties. A representation may be associated with a given quality level expressed as a bitrate. The data stream of each representation is provided by the DASH Segment delivery function 220 and is divided into temporal segments (also called chunks or segments) of equal duration (e.g. few seconds), accessible by a separate URL. The plurality of segments is prepared by the DASH Media Presentation Preparation 210. Different versions of each segment are prepared, ready to be provided to the clients. When playing a content, a DASH client may smoothly switch from one quality level to another between two segments, in order to dynamically adapt to network conditions. When low bandwidth is available, a client requests low bitrate chunks and they may request higher bitrate chunks when higher bandwidth becomes available. As a result, the video quality may vary while playing but rarely suffers from interruptions (also called freezes).

At the client side, the segments may be selected based on a measure of the available bandwidth of the transmission path. In particular, a DASH client usually requests the representation of a segment corresponding to a bitrate encoding and thus a quality compliant with the measured bandwidth.

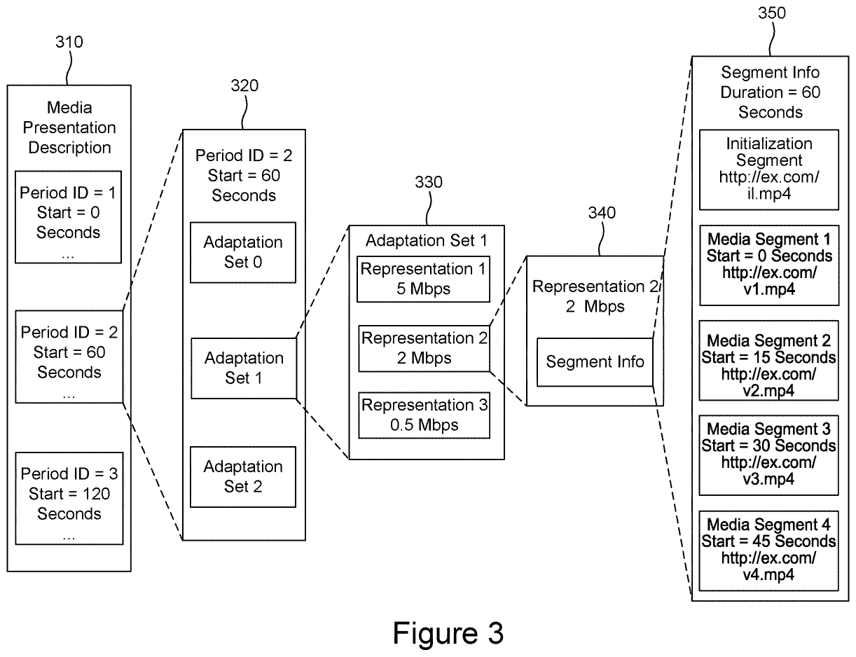

FIG. 3 illustrates an example of Media Presentation Description based on DASH. The Media Presentation Description 310 comprises period elements (regular periods, early available periods, etc.) of equal length (60 seconds in the example), each period being identified by a Period ID, a start value representing the start time with respect to the first frame of the multimedia content of the period and a duration. Each period 320 comprises one or more adaptation sets 330 which contain(s) alternate representations of the multimedia components considered to be perceptually equivalent. Adaptation set and the contained representations shall be prepared and contain sufficient information such that seamless switching across different representations in one adaptation set is possible. Multimedia content components being video, audio, teletext, subtitle, etc. Each representation 340 comprises segment info 350 that itself comprises different sub-segments having relative start time with respect to the current segment. From one period to another, adaptation sets and the contained representations can be different.

Embodiments described herein introduce a mechanism for transmitting a pixel-wise Attenuation Map in an adaptive video streaming environment and therefore allows a receiver device to control its energy reduction rate when displaying the video. At least one embodiment is based on a new type of adaptation set for DASH. Such set is characterized by having an identifier (@id) attribute comprising the string “ami” standing for “Attenuation Map Information” for example or comprising another string representing the notion of attenuation map signaling (e.g., “amid” for attenuation map identifier, “am” for attenuation map, “dm” for dimming map, “dpr” for display power reduction). This string is known by the DASH server and the DASH client. This identifier indicates that the adaptation set comprises attenuation map information. Such adaptation set allows to list in a DASH MPD the pixel-wise Attenuation Map representations available on the DASH server as different representations and thus allows a DASH client to select one of them to control its energy reduction rate when displaying the video. Instead of using the identifier @id=“ami” to identify the new type of Adaptation Set Element, the attribute @contentType of an adaptation set may be set to “Attenuation Map” for example or “am” or other strings as discussed above to inform that the Adaptation Set Element signals Attenuation Map representations. In at least one embodiment, instead of using the @id or @contentType attributes, the Attenuation Map adaptation set is signaled using a role scheme element (<Role schemeIdUri=“urn:mpeg:dash:role:2011” value=“ami”/>). Such element is added in the adaptation set element with a role value set to “ami” for example or to other strings as discussed above. Despite this variation in the signaling of the information, the overall principle stays the same. In the rest of the document, the formalism @id=“ami” will be used for simplification to cover all these cases.

A DASH client may also select multiple “ami” adaptation sets with a different AdaptationSet@group value (i.e. AdaptationSet with the same @group attribute value are alternated), for example identified by @id-“amiX”, with X in the range 0 . . . n, in the MPD manifest file, and therefore allow a selection of the appropriate attenuation map corresponding to a chosen energy reduction in the case where the adaptation sets have different values for the energy reduction. For example, this allows the dash client to request and receive multiple Attenuation Maps at the same time and perform approximation operation to obtain different values of energy reduction without requesting an additional Attenuation Map from the dash server. The same principle applies to the other parameters of the adaptation set. According to its energy consumption strategy, a DASH client may also ignore the “ami” adaptation set. In this case, no pixel-wise Attenuation Map representation is requested by the dash client and the video is displayed without any modification. As a result, the DASH client will not benefit from the energy reduction.

According to at least one embodiment, the “ami” adaptation set provides information on how to use the pixel-wise Attenuation Map representation, the type of displays on which to apply the Attenuation Map representation, the type of post-processing to further use the Attenuation Map representation, the type of downsampling and its subsequent upsampling if any to apply as a preprocessing before using the Attenuation Map representation on an image, and indicative metrics of the expected energy reduction and on the expected quality impact of the use of such an Attenuation Map representation.

According to at least one embodiment, the “ami” adaptation set is dynamically updated within the DASH MPD per period and the granularity of the update can be based on time (per period/duration of the video content), on temporal layers (per temporal layer), on slice type (per intra and inter slices) or on parts of the picture (Slices, Tiles, Sub-pictures).

The MPD comprising the new adaptation set @id=“ami” is hereafter named as AMI-MDP. It is generated at the DASH server, based on information provided by a processing block that handles the generation and encoding of the Attenuation Map from an input image. The AMI-MPD is parsed by a DASH client. In response, a pixel-wise Attenuation Map representation, for example corresponding to a target reduction rate, is selected and requested from the DASH server. When received, the information from the adaptation set and the representations are provided to the media engine, and to the post-processing module if required, to apply the selected Attenuation Map representation to the video component representation. This results in a reduced energy consumption of the DASH client since the image displayed will require less energy than the original image.

According to at least one embodiment, multiple Attenuation Map representations are requested and combined. This allows to produce a new Attenuation Map with an intermediate reduction rate, not directly available in the list of Attenuation Map representations. The new attenuation could be generated by interpolating two Attenuation Map representations according to a weighting corresponding to the respective attenuation rates.

In such enhanced ecosystem, the DASH server and client are energy-aware devices in the sense that an energy-aware DASH server prepares data that are needed to allow an energy-aware DASH client to control its energy consumption through the selection, reception, and application of a pixel-wise dimming map.

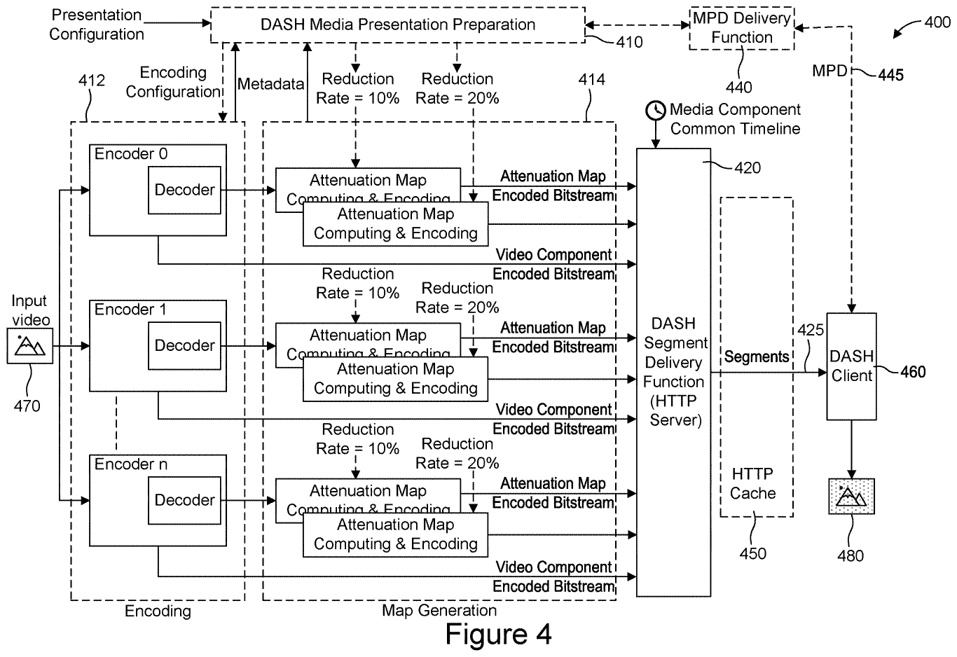

FIG. 4 illustrates an example of architecture for an energy-aware DASH server according to an embodiment. This architecture 400 is for example implemented by a content provider server 180 of FIG. 1. The original input video 470 is provisioned to the DASH system to an Encoding module 412 that prepares and encodes the input video as described in relation with FIGS. 2 and 3, i.e., splitting the video into segments and encoding the segments for different video representations with for example different bitrates, different spatial resolutions, and/or different frame rates. The Map Generation module 414 determines, from decoded images of these different video representations, a set of corresponding Attenuation Maps, one Attenuation Map per decoded image. These maps are then conventionally encoded in so-called Attenuation Map representations using the same principle as for video segments. Multiple Attenuation Map representations may be used, for example with different energy reduction rates, as illustrated in the figure (one representation with 10% reduction, and a second representation with 20%). The DASH media presentation preparation module 410 handles the preparation of the data used within the system by driving the Encoding module 412 and the Map Generation module 414, for example establishing the set of different bitrates, different spatial resolutions, and/or different frame rates for the different video representations as well as listing the reduction rates for which Attenuation Maps should be generated. The DASH media presentation preparation module 410 then generates the MPD manifest file, that comprises an “ami” adaptation set and the Attenuation Map Representations, from metadata obtained from the Encoding module 412 and the Map Generation module 414. The metadata provides information for the element attributes of the adaptation set and representations (for example: energy reduction rate, usage of the Attenuation Map, etc.). The MPD manifest file is provided to the MPD delivery function 440 to respond to requests from the DASH Client. The data generated by the Encoding module 412 and the Map Generation module 414 are combined by the DASH Segment delivery function 420 to create the segments of the different video representations and the segments of the Attenuation Maps representations. These segments 425, including the video related segments and the corresponding Attenuation Map representations (i.e., 10% or 20% in the example of the figure), will then be retrieved by a DASH client 460 according to the information of the MPD manifest file 445 and to a selected energy reduction strategy. As described below with respect to FIG. 5, the DASH client will then apply the attenuation to the video to generate an energy-aware image 480 that will require less energy when being displayed on a screen than the original image 470.

The segments are cached in an HTTP cache 450 for performance reasons. This cache is handled so that only the relevant segments of a selected video representation amongst the multiple video representations and only the segments of the selected Attenuation Map representations are available in the cache, thus ensuring a minimal load on the distribution network. Segment formats are based on ISO BMFF with fragmented movie files, i.e. (Sub) Segments are encoded as movie fragments containing a track fragment as defined in ISO/IEC 14496-12 [7] with the constraints of being independently decodable.

FIG. 5 illustrates an example of architecture for an energy-aware DASH client according to an embodiment. This architecture 500 is for example implemented by a display device 100 of FIG. 1. The figure illustrates the logical components of a DASH client and the relation to other components in a media streaming application. The DASH client is operated under control of a Media Streaming Application 510. The DASH access engine 540 requests and receives from the server the Media Presentation Description (MPD) containing information related to both Video Media component representations and the “ami” adaptation set with a list of Attenuation Map representations associated with the video media component representation. The energy reduction metadata are provided to the Selection Logic module 520. The energy reduction metadata includes information about the Attenuation Map representations, how to use them to reduce the energy consumption when the video component is presented on the display, the expected reduction rate and the associated quality or experience metric. The Selection Logic module may use the energy reduction metadata to select the media components of the service, requested by the Media Streaming application 510, through interactions with the energy consumption module 530. This module receives from the Media Streaming application 510 the energy profile determined by the energy reduction strategy of the device itself or the End-user and provides the requested reduction rates to the Selection Logic module 520. Upon a selection of the representations, the Media Streaming application 510 configures the Decoding module 550 (e.g. codec, number of Attenuation Map representations, . . . ), the Attenuation Map post-processing 580, 581, the application module 560 and the rendering module 570. Thus, the DASH access engine 540 requests and receives the video media segments and the Attenuation Map representation segments corresponding to the selected representation. The Attenuation Map and the Video component representations are decoded by the decoding module 550. The Attenuation Map representations are optionally post-processed when needed (for example for up-scaling). The Attenuation Map representations are combined with the video by the application module 560 and the resulting video is rendered on the display by a video rendering module 570.

Table 1 illustrates a list of new attribute names of an “ami” adaptation set for a DASH MPD according to an embodiment.

TABLE 1

| New Attribute Name | Description |
|---|---|
| @amiDisplayModel | indicates on which type(s) of displays, the Attenuation |
| | Map representation should be applied at the receiver |
| | side. For example, @amiDisplayModel may indicate all |
| | types of emissive displays such as OLED displays. |
| @amiMapApproximationModel | indicates which type of interpolation models should be |
| | used to infer an Attenuation Map representation of a |
| | different reduction rate that the ones corresponding to |
| | the available Attenuation Map representations |
| @amiAttenuationUseIdc | indicates which type of processing should be used to |
| | apply the current Attenuation Map representation(s) on |
| | the associated video component representation to be |
| | displayed. For example, the Attenuation Map |
| | representation can be subtracted, added or multiplied to |
| | the associated video component representation, so that it |
| | reduces the level of the pixel values. |
| @amiAttenuationCompIdc | indicates the mapping between the components of the |
| | Attenuation Map representation(s) and the components |
| | of the associated video component representation, while |
| | applying the Attenuation Map representation(s). |

Table 2 represents the different values for the @amiDisplayModel attribute. This attribute is a bit field mask which indicates the display models on which the Attenuation Map representation can be used. A bit field is used to provide better control over the possible combinations. For example, @amiDisplayModel=0x3 means that the Attenuation Map representation can be used for both Non emissive (Bit 0 is set) and Emissive display models (Bit 1 is set).

TABLE 2

| Bit | Display Model |
|---|---|
| Bit 0 | Non emissive |
| Bit 1 | Emissive |
| Bit 2 . . . 3 | Reserved for future types |

The @amiDisplayModel attribute is set in the “ami” Adaptation Set when it is created in order to indicate to the DASH client that the available Attenuation Map Representations can only be used for a given Display type. Then the DASH client can perform the appropriate request to the DASH server and not request the Attenuation Map representations that it cannot use with the Display to which it is connected. This embodiment allows to reduce unnecessary transmission of data between the DASH server and the DASH client.

Table 3 represents the different values for the @amiMapApproximationModel attribute. This attribute specifies the interpolation model used to extrapolate Attenuation Map representation sample values from a set of Attenuation Map representation with individual energy reduction rates to another set of Attenuation Map representation sample values with a different energy reduction rate. A value equal to 0 specifies that a linear scaling of the Attenuation Map representation sample values of the current Attenuation Map representation given its respective @amiEnergyReductionRate should be considered to obtain corresponding Attenuation Map representation sample values for another energy reduction rate. A value equal to 1 specifies that an interpolation of type Lanczos between the Attenuation Map representation sample values of the current Attenuation Map representation given their respective @amiEnergyReductionRate should be considered to obtain corresponding Attenuation Map representation sample values for another energy reduction rate. A value equal to 2 specifies that an interpolation of type bicubic between the Attenuation Map representation sample values of the current Attenuation Map representation given their respective @amiEnergyReductionRate should be considered to obtain corresponding Attenuation Map representation sample values for another energy reduction rate. A value equal to 3 specifies that a proprietary user defined process should be used to infer corresponding Attenuation Map representation sample values for another energy reduction rate from the Attenuation Map representation sample values given their respective @amiEnergyReductionRate. The approximation model is applicable to all the Attenuation Map representations within a current Adaptation Set.

TABLE 3

| | Process to interpolate another |
|---|---|
| Value | Attenuation Map representation |
| 0 | Linear scaling |
| 1 | Lanczos interpolation |
| 2 | Bicubic interpolation |
| 3 | User defined |
| 4 . . . 15 | Reserved for future uses |

Table 4 represents the different values for the @amiAttenuationUseIdc. This attribute specifies how the Attenuation Map representation should be applied to the samples of the associated video component representation before displayed on screen. Indeed, this depends on how the attenuation map has been generated. Several options are thus possible. A value equal to 0 specifies that the Attenuation Map representation sample should be added to the samples of the associated video component representation before being displayed on screen. A value equal to 1 specifies that the Attenuation Map representation sample should be subtracted to the samples of the associated video component representation before being displayed on screen. A value equal to 2 specifies that the Attenuation Map representation sample should be multiplied to the samples of the associated video component representation before being displayed on screen. A value equal to 3 specifies that the Attenuation Map representation sample should be used according to a proprietary user defined process to the samples of the associated video component representation before being displayed on screen.

TABLE 4

| | Process to apply on associated |
|---|---|
| Value | primary picture decoded samples |
| 0 | Addition |
| 1 | Subtraction |
| 2 | Multiplication |
| 3 | User defined |
| 4 . . . 15 | Reserved for future uses |

Table 5 represents the different values for the @amiAttenuationCompIdc attribute. This attribute specifies on which component(s) of the associated video component representation the Attenuation Map representation should be applied using the process defined by @amiAttenuationUseIdc. It also specifies how many components the Attenuation Map representation should contain. A value equal to 0 specifies that the Attenuation Map representation contains only one component and that this component should be applied to the luma component of the associated video component representation. A value equal to 1 specifies that the Attenuation Map representation contains two components and that the first component should be applied to the luma component of the associated video component representation, and the second component should be applied to both chroma components of the associated video component representation. A value equal to 2 specifies that the Attenuation Map representation contains only one component and that this component should be applied to the luma component and the chroma components of the associated video component representation. A value equal to 3 specifies that the Attenuation Map representation contains only one component and that this component should be applied to the RGB components (after YUV to RGB conversion) of the associated video component representation. A value equal to 4 specifies that the Attenuation Map representation contains three components and that these components should be applied respectively to the luma and chroma components of the associated video component representation. A value equal to 5 specifies that the Attenuation Map representation contains three components and that these components should be applied respectively to the RGB components (after YUV to RGB conversion) of the associated video component representation. A value equal to 6 specifies that the mapping between the components of the associated video component representation and the components of which to apply the Attenuation Map representation corresponds to proprietary user-defined processes.

TABLE 5

| | Mapping between components of the Attenuation Map representation |
|---|---|
| | and components of the associated video component representation on which |
| Value | to apply the Attenuation Map |
| 0 | One component in the Attenuation Map representation applied to the luma |
| | component of the associated video component representation |
| 1 | Two components in the Attenuation Map representation applied as: |
| | First component to luma component |
| | Second component to the chroma components |
| | of the associated video component representation |
| 2 | One component in the Attenuation Map representation applied to the luma and |
| | chroma components of the associated video component representation. |
| 3 | One component in the Attenuation Map representation applied to the three |
| | RGB components of the associated video component representation |
| 4 | Three components in the Attenuation Map representation applied to resp. |
| | luma and chroma components of the associated video component |
| | representation |
| 5 | Three components in the Attenuation Map representation applied to resp. the |
| | RGB components of the associated video component representation |
| 6 | User defined |
| 7 . . . 15 | Reserved for future uses |

Table 6 illustrates a list of new syntax elements to be used to specify attributes of a “ami” adaptation set for a DASH MPD according to an embodiment.

TABLE 6

| | |
|---|---|
| @amiBoxXstart | defines the x coordinate of the top left corner of the |
| | bounding box defining the region of the associated video |
| | component representation to apply the Attenuation Map |
| | representation |
| @amiBoxYstart | defines the y coordinate of the top left corner of the |
| | bounding box defining the region of the associated video |
| | component representation to apply the Attenuation Map |
| | representation |
| @amiBoxWidth | defines the width of the bounding box defining the region |
| | of the associated video component representation to apply |
| | the Attenuation Map representation |
| @amiBoxHeight | defines the height of the bounding box defining the region |
| | of the associated video component representation to apply |
| | the Attenuation Map representation |
| @amiPreprocessingTypeIdc | specifies the recommended type of the interpolation (e.g., |
| | bicubic) used to pre-upsample the Attenuation Map |
| | representation samples before applying it on the |
| | associated video component representation. |
| @amiPreprocessingScale | specifies which scaling should be applied to the |
| | Attenuation Map representation to obtain the Attenuation |
| | Map representation sample values before applying it on |
| | the associated video component representation. |
| @amiMaxValue | indicates the maximum value of the Attenuation Map |
| | representation. Such a maximal value can be optionally |
| | used to further adjust the dynamic of the encoded |
| | Attenuation Map representation in the scaling process. |
| @amiEnergyReductionRate | indicates for the current Attenuation Map representation |
| | the corresponding level of energy reduction in % that can |
| | be expected from the use of the Attenuation Map |
| | representation. |
| @amiVideoQualityMetric | indicates the quality metric considered by the DASH |
| | server when it computes the value of the elements |
| | @amiVideoQuality or @amiVideoQualityReduction. |
| @amiVideoQuality | indicates for the Attenuation Map representation the |
| | corresponding quality than can be expected after using the |
| | Attenuation Map representation to reduce the energy of |
| | the original image. |
| @amiVideoQualityReduction | indicates the percentage of reduction when the |
| | Attenuation Map is applied on the associated video |
| | component representation, according to the selected |
| | quality metric (@amiVideoQualityMetric) |
| @amiPreprocessingScale | specifies which scaling should be applied to the |
| | Attenuation Map representation to obtain the Attenuation |
| | Map representation sample values before applying it on |
| | the associated video component representation. |

The @amiBoxXstart, @amiBoxYstart, @amiBoxWidth, @amiBoxHeight elements define respectively the x coordinate, y coordinate of the left corner, width and height of the bounding box defining a region of the decoded picture on which the Attenuation Map representation must be applied, the region being smaller than the size of the decoded picture. The size of the Attenuation Map representation should be defined accordingly.

Table 7 represents the different values for the @amiPreprocessingTypeIdc element. This element, if present, specifies the recommended type of the interpolation (e.g., bicubic) used to pre-upsample the Attenuation Map representation sample values. This allows to use down-sampled Attenuation Map representations that need less bits to be stored and to be transmitted. A value equal to 0 specifies that an interpolation of type bicubic between the Attenuation Map representation sample values should be considered to obtain the Attenuation Map representation sample values to apply to the sample values of the associated video component representation. A value equal to 1 specifies that an interpolation of type Lanczos between the Attenuation Map representation sample values should be considered to obtain the Attenuation Map representation sample values to apply to the sample values of the associated video component representation. A value equal to 2 specifies that a proprietary user defined process should be used to pre-upsample the Attenuation Map representation sample values to apply to the sample values of the associated video component representation.

TABLE 7

| | Process to interpolate another |
|---|---|
| Value | Attenuation Map representation |
| 0 | Bicubic interpolation |
| 1 | Lanczos interpolation |
| 2 | User defined |
| 3 . . . 15 | Reserved for future uses |

Table 8 represents the different values for the @amiPreprocessingScale element. This element specifies which scaling should be applied to the Attenuation Map representation to obtain the Attenuation Map representation sample values before applying it on the associated video component representation. A value equal to 0 specifies that a scaling of 1.0/255.0 should be applied to the Attenuation Map representation. A value equal to 1 specifies that a proprietary user defined scaling should be applied to the Attenuation Map representation.

TABLE 8

| | Attenuation Map representation |
|---|---|
| @amiPreprocessingScaleI | scaling preprocess |
| 0 | Scaling of 1.0/255.0 |
| 1 | User defined |
| 2 . . . 15 | Reserved for future uses |

The @amiMax Value element indicates the maximum value of the Attenuation Map representation before being preprocessed and encoded. Such a maximal value can be optionally used to further adjust the dynamic of the encoded Attenuation Map representation in the scaling process.

The @amiEnergyReductionRate element indicates the expected energy saving rate when the associated video component representation is displayed after applying the Attenuation Map representation sample values of the current Attenuation Map representation. In at least one embodiment, the @amiEnergyReductionRate is expressed as a percentage of reduction. In at least one embodiment, the @amiEnergyReductionRate is expressed as a value of reduction in Watt.

Table 9 represents the different values for the @amiVideoQualityMetric element. The @amiVideoQualityMetric element indicates the quality metric considered to compute the @amiVideoQuality and/or the @amiVideoQualityReduction element value of the displayed video after applying the Attenuation Map representation sample values of the current Attenuation Map representation.

TABLE 9

| @amiVideoQualityMetric | Quality Metrics |
|---|---|
| 0x00 | PSNR |
| 0x01 | SSIM |
| 0x02 | wPSNR |
| 0x03 | WS-PSNR |
| 0x04 | V-MAF |
| 0x05 . . . 0x07 | Reserved for |
| | future uses |

The @amiVideoQuality element specifies the quality of the displayed video after applying the Attenuation Map representation sample values of the current Attenuation Map representation. Examples of metric value that can be stored in @amiVideoQuality are PSNR, SSIM, wPSNR, WS-PSNR or V-MAF values, as indicated in the Table 9, for the modified picture after applying the Attenuation Map representation. Such quality metrics can be computed by the decoder but, for the sake of reducing the energy consumption, they could also be inferred at the encoder side. In this case, they could correspond to values of expected minimal quality. Instead of using the @ami VideoQuality element, the @ami VideoQualityReduction element can be used. This element specifies the video quality reduction compared to the nominal value of the video quality of the associated video component representation when the Attenuation Map representation is not applied.

Table 10 represents a first example of MPD manifest file comprising the information allowing to reduce the energy consumption when displaying a video according to an embodiment. This example uses one Adaptation Set of @id=ami and mimetype=video/mp4 corresponding to the type of the Attenuation Map representations, one Attenuation Map representation of @id=“ami0” associated with the associated type=“amit” to the Video Component representation @id=“v0”, which can be used for emissive and non-emissive displays (amiDisplayModel=“3”) allowing to reduce the energy consumption of 20% (amiEnergyReductionRate=“20”) with a reduction of the PSNR Quality Video metric value of 5% and with a linear approximation model (amiMapApproximationModel=“0”).

```
TABLE 10
<?xml version=”1.0” encoding=”UTF-8”?>
<MPD
  xmlns:xsi=″http://www.w3.org/2001/XMLSchema-instance″
  xmlns=″urn:mpeg:DASH:schema:MPD:XXXX″
  xsi:schemaLocation=″urn:mpeg:DASH:schema:MPD:xxxx″
  type=″dynamic″
  minimumUpdatePeriod=″PT2S″
  timeShiftBufferDepth=″PT30M″
  availabilityStartTime=″2011-12-25T12:30:00″
  minBufferTime=″PT4S″
  profiles=″urn:mpeg:dash:profile:isoff-live:2011″>
  <BaseURL>http://cdn1.example.com/</BaseURL>
  <BaseURL>http://cdn2.example.com/</BaseURL>
  <Period>
    <!-- Video -->
    <AdaptationSet
      id=″video″
      mimeType=″video/mp4″
      codecs=″avc1.4D401F″
      frameRate=″30000/1001″
      segmentAlignment=″true″
      startWithSAP=″1″>
      <BaseURL>video/</BaseURL>
      <SegmentTemplate timescale=″90000″ media=″$Bandwidth$/$Time$.mp4v″>
        <SegmentTimeline>
          <S t=″0″ d=″180180″ r=″432″/>
        </SegmentTimeline>
      </SegmentTemplate>
      <Representation id=″v0″ width=″320″ height=″240″ bandwidth=″250000″/>
      <Representation id=″v1″ width=″640″ height=″480″ bandwidth=″500000″/>
      <Representation id=″v2″ width=″960″ height=″720″ bandwidth=″1000000″/>
    </AdaptationSet>
    <!-- English Audio -->
    <AdaptationSet mimeType=″audio/mp4″ codecs=″mp4a.0x40″ lang=″en″
segmentAlignment=″0″>
      <SegmentTemplate timescale=″48000″ media=″audio/en/$Time$.mp4a″>
        <SegmentTimeline>
          <S t=″0″ d=″96000″ r=″432″/>
        </SegmentTimeline>
      </SegmentTemplate>
      <Representation id=″a0″ bandwidth=″64000″ />
    </AdaptationSet>
    <!-- French Audio -->
    <AdaptationSet mimeType=″audio/mp4″ codecs=″mp4a.0x40″ lang=″fr″
segmentAlignment=″0″>
      <SegmentTemplate timescale=″48000″ media=″audio/fr/$Time$.mp4a″>
        <SegmentTimeline>
          <S t=″0″ d=″96000″ r=″432″/>
        </SegmentTimeline>
      </SegmentTemplate>
      <Representation id=″a0″ bandwidth=″64000″ />
    </AdaptationSet>
<!--AdaptationSet carrying Attenuation Maps for display energy reduction for
Video -->
    <AdaptationSet id=″ami″ mimeType=″video/mp4″ codecs=″avc1.4D401F″
amiDisplayModel=”3” amiAttenuationUseIdc=”1” >
      <BaseURL>attenuation_maps/</BaseURL>
      <SegmentTemplate timescale=″90000″ media=″$id$/$Time$.mp4v″>
        <SegmentTimeline>
          <S t=″0″ d=″180180″ r=″432″/>
        </SegmentTimeline>
      </SegmentTemplate>
      <Representation id=″ami0″ bandwidth=″1000″ associationId=″v0″
        associationType=″amit″ amiEnergyReductionRate=”20”
amiVideoQualityMetric=”PSNR” amiVideoQualityReduction=”5”
amiMapApproximationModel=”0”/>
    </AdaptationSet>
  </Period>
</MPD>
```

In the example of table 10, the attributes @associationId and @associationType are carried by the Attenuation Map representation element. In another implementation, the attributes @associationId and @associationType are common attributes to all attenuation map representations and are carried directly by the Adaptation Set Element.

Table 11 represents a second example of MPD manifest file comprising the information allowing to reduce the energy consumption when displaying a video according to an embodiment. This second example uses one Adaptation Set of @id=ami and mimetype=video/mp4 corresponding to the type of the Attenuation Maps, Two Attenuation Map representations of @id=“ami” and @id=“amil” associated to the Video Component representation @id=“v0”, both attenuation Maps being used for emissive and non-emissive displays, one attenuation Map allowing to reduce the energy consumption by 20% and another by 40%, and both maps using a Lanczos approximation model (amiMapApproximationModel=“1”).

```
TABLE 11
<?xml version=”1. 0” encoding=”UTF-8”?>
<MPD
  xmlns:xsi=″http://www.w3.org/2001/XMLSchema-instance″
  xmlns=″urn:mpeg:DASH:schema:MPD:XXXX″
  xsi:schemaLocation=″urn:mpeg:DASH:schema:MPD:xxxx″
  type=″dynamic″
  minimumUpdatePeriod=″PT2S″
  timeShiftBufferDepth=″PT30M″
  availabilityStartTime=″2011-12-25T12:30:00″
  minBufferTime=″PT4S″
  profiles=″urn:mpeg:dash:profile:isoff-live:2011″>
  <BaseURL>http://cdn1.example.com/</BaseURL>
  <BaseURL>http://cdn2.example.com/</BaseURL>
  <Period>
    <!-- Video -->
    <AdaptationSet
      id=″video″
      mimeType=″video/mp4″
      codecs=″avc1.4D401F″
      frameRate=″30000/1001″
      segmentAlignment=″true″
      startWithSAP=″1″>
      <BaseURL>video/</BaseURL>
      <SegmentTemplate timescale=″90000″ media=″$Bandwidth$/$Time$.mp4v″>
        <SegmentTimeline>
          <S t=″0″ d=″180180″ r=″432″/>
        </SegmentTimeline>
      </SegmentTemplate>
      <Representation id=″v0″ width=″320″ height=″240″ bandwidth=″250000″/>
      <Representation id=″v1″ width=″640″ height=″480″ bandwidth=″500000″/>
      <Representation id=″v2″ width=″960″ height=″720″ bandwidth=″1000000″/>
    </AdaptationSet>
    <!-- English Audio -->
    <AdaptationSet mimeType=″audio/mp4″ codecs=″mp4a.0x40″ lang=″en″
segmentAlignment=″0″>
      <SegmentTemplate timescale=″48000″ media=″audio/en/$Time$.mp4a″>
        <SegmentTimeline>
          <S t=″0″ d=″96000″ r=″432″/>
        </SegmentTimeline>
      </SegmentTemplate>
      <Representation id=″a0″ bandwidth=″64000″ />
    </AdaptationSet>
    <!-- French Audio -->
    <AdaptationSet mimeType=″audio/mp4″ codecs=″mp4a.0x40″ lang=″fr″
segmentAlignment=″0″>
      <SegmentTemplate timescale=″48000″ media=″audio/fr/$Time$.mp4a″>
        <SegmentTimeline>
          <S t=″0″ d=″96000″ r=″432″/>
        </SegmentTimeline>
      </SegmentTemplate>
      <Representation id=″a0″ bandwidth=″64000″ />
    </AdaptationSet>
<!--AdapatationSet carrying Attenuation Maps for display energy reduction for
Video -->
    <AdaptationSet id=″ami″ mimeType=″video/mp4″ codecs=″avc1.4D401F″
amiDisplayModel=”3” amiAttenuationUseIdc=”1” >
      <BaseURL>attenuation_maps/</BaseURL>
      <SegmentTemplate timescale=″90000″ media=″$id$/$Time$.mp4v″>
        <SegmentTimeline>
          <S t=″0″ d=″180180″ r=″432″/>
        </SegmentTimeline>
      </SegmentTemplate>
      <Representation id=″ami0″ bandwidth=″1000″ associationId=″v0″
        associationType=″amit″ amiEnergyReductionRate=”20”
amiMapApproximationModel=”1”/>
      <Representation id=″ami1″ bandwidth=″1000″ associationId=″v0″
        associationType=″amit″ amiEnergyReductionRate=”40”
amiMapApproximationModel=”1”/>
    </AdaptationSet>
  </Period>
</MPD>
```

Table 12 represents a third example of MPD manifest file comprising the information allowing to reduce the energy consumption when displaying a video according to an embodiment. This example uses one Adaptation Set with the role schemeIdUri of value=‘ami’, mimetype=video/mp4 corresponding to the type of the Attenuation Map representations, one Attenuation Map representation of @id=“ami0” associated with the associated type=“gmam” to the Video Component representation @id=“v0”, which can be used for emissive and non-emissive displays (amiDisplayModel=“3”) allowing to reduce the energy consumption of 20% (amiEnergyReductionRate=“20”) with a reduction of the PSNR Quality Video metric value of 5% and with a linear approximation model (amiMapApproximationModel=“0”).

```
TABLE 12
<?xml version=”1.0” encoding=”UTF-8”?>
<MPD
  xmlns:xsi=″http://www.w3.org/2001/XMLSchema-instance″
  xmlns=″urn:mpeg:DASH:schema:MPD:XXXX″
  xsi:schemaLocation=″urn:mpeg:DASH:schema:MPD:xxxx″
  type=″dynamic″
  minimumUpdatePeriod=″PT2S″
  timeShiftBufferDepth=″PT30M″
  availabilityStartTime=″2011-12-25T12:30:00″
  minBufferTime=″PT4S″
  profiles=″urn:mpeg:dash:profile:isoff-live:2011″>
  <BaseURL>http://cdn1.example.com/</BaseURL>
  <BaseURL>http://cdn2.example.com/</BaseURL>
  <Period>
    <!-- Video -->
    <AdaptationSet
      id=″video″
      mimeType=″video/mp4″
      codecs=″avc1.4D401F″
      frameRate=″30000/1001″
      segmentAlignment=″true″
      startWithSAP=″1″>
      <BaseURL>video/</BaseURL>
      <SegmentTemplate timescale=″90000″ media=″$Bandwidth$/$Time$.mp4v″>
        <SegmentTimeline>
          <S t=″0″ d=″180180″ r=″432″/>
        </SegmentTimeline>
      </SegmentTemplate>
      <Representation id=″v0″ width=″320″ height=″240″ bandwidth=″250000″/>
      <Representation id=″v1″ width=″640″ height=″480″ bandwidth=″500000″/>
      <Representation id=″v2″ width=″960″ height=″720″ bandwidth=″1000000″/>
    </AdaptationSet>
    <!-- English Audio -->
    <AdaptationSet mimeType=″audio/mp4″ codecs=″mp4a.0x40″ lang=″en″
segmentAlignment=″0″>
      <SegmentTemplate timescale=″48000″ media=″audio/en/$Time$.mp4a″>
        <SegmentTimeline>
          <S t=″0″ d=″96000″ r=″432″/>
        </SegmentTimeline>
      </SegmentTemplate>
      <Representation id=″a0″ bandwidth=″64000″ />
    </AdaptationSet>
    <!-- French Audio -->
    <AdaptationSet mimeType=″audio/mp4″ codecs=″mp4a.0x40″ lang=″fr″
segmentAlignment=″0″>
      <SegmentTemplate timescale=″48000″ media=″audio/fr/$Time$.mp4a″>
        <SegmentTimeline>
          <S t=″0″ d=″96000″ r=″432″/>
        </SegmentTimeline>
      </SegmentTemplate>
      <Representation id=″a0″ bandwidth=″64000″ />
    </AdaptationSet>
<!--AdaptationSet carrying Attenuation Maps for display energy reduction for
Video -->
    <AdaptationSet mimeType=″video/mp4″ codecs=″avc1.4D401F″ amiDisplayModel=”3”
amiAttenuationUseIdc=”1” >
      <BaseURL>attenuation_maps/</BaseURL>
      <Role schemeIdUri=″urn:mpeg:dash:role:2011″ value=″ami″/>
      <SegmentTemplate timescale=″90000″ media=″$id$/$Time$.mp4v″>
        <SegmentTimeline>
          <S t=″0″ d=″180180″ r=″432″/>
        </SegmentTimeline>
      </SegmentTemplate>
      <Representation id=″ami0″ bandwidth=″1000″ associationId=″v0″
        associationType=″gmam″ amiEnergyReductionRate=”20”
amiVideoQualityMetric=”PSNR” amiVideoQualityReduction=”5”
amiMapApproximationModel=”0”/>
    </AdaptationSet>
  </Period>
</MPD>
```

Table 13 represents a fourth example of MPD manifest file comprising the information allowing to reduce the energy consumption when displaying a video according to an embodiment. This example uses two Adaptation Sets of @id=ami and @group=‘10’. The Attenuation Map representation of each Adaptation Set of @id=“ami0” and @id=“amil” are associated with the associated type=“gmam” to the Video Component representation @id=“v0”. They can be used for emissive and non-emissive displays (amiDisplayModel=“3”) allowing to reduce the energy consumption of 20% (amiEnergyReductionRate=“20”) or 10% (amiEnergyReductionRate=“10”) with a reduction of the PSNR Quality Video metric value of 5% and with a linear approximation model (amiMapApproximationModel=“0”).

```
TABLE 13
<?xml version=”1.0” encoding=”UTF-8”?>
<MPD
  xmlns:xsi=″http://www.w3.org/2001/XMLSchema-instance″
  xmlns=″urn:mpeg:DASH:schema:MPD:XXXX″
  xsi:schemaLocation=″urn:mpeg:DASH:schema:MPD:xxxx″
  type=″dynamic″
  minimumUpdatePeriod=″PT2S″
  timeShiftBufferDepth=″PT30M″
  availabilityStartTime=″2011-12-25T12:30:00″
  minBufferTime=″PT4S″
  profiles=″urn:mpeg:dash:profile:isoff-live:2011″>
  <BaseURL>http://cdn1.example.com/</BaseURL>
  <BaseURL>http://cdn2.example.com/</BaseURL>
  <Period>
    <!-- Video -->
    <AdaptationSet
      id=″video″
      mimeType=″video/mp4″
      codecs=″avc1.4D401F″
      frameRate=″30000/1001″
      segmentAlignment=″true″
      startWithSAP=″1″>
      <BaseURL>video/</BaseURL>
      <SegmentTemplate timescale=″90000″ media=″$Bandwidth$/$Time$.mp4v″>
        <SegmentTimeline>
          <S t=″0″ d=″180180″ r=″432″/>
        </SegmentTimeline>
      </SegmentTemplate>
      <Representation id=″v0″ width=″320″ height=″240″ bandwidth=″250000″/>
      <Representation id=″v1″ width=″640″ height=″480″ bandwidth=″500000″/>
      <Representation id=″v2″ width=″960″ height=″720″ bandwidth=″1000000″/>
    </AdaptationSet>
    <!-- English Audio -->
    <AdaptationSet mimeType=″audio/mp4″ codecs=″mp4a.0x40″ lang=″en″
segmentAlignment=″0″>
      <SegmentTemplate timescale=″48000″ media=″audio/en/$Time$.mp4a″>
        <SegmentTimeline>
          <S t=″0″ d=″96000″ r=″432″/>
        </SegmentTimeline>
      </SegmentTemplate>
      <Representation id=″a0″ bandwidth=″64000″ />
    </AdaptationSet>
    <!-- French Audio -->
    <AdaptationSet mimeType=″audio/mp4″ codecs=″mp4a.0x40″ lang=″fr″
segmentAlignment=″0″>
      <SegmentTemplate timescale=″48000″ media=″audio/fr/$Time$.mp4a″>
        <SegmentTimeline>
          <S t=″0″ d=″96000″ r=″432″/>
        </SegmentTimeline>
      </SegmentTemplate>
      <Representation id=″a0″ bandwidth=″64000″ />
    </AdaptationSet>
<!--AdaptationSet carrying Attenuation Maps for display energy reduction for
Video -->
    <AdaptationSet id=″ami″ group=’10’ mimeType=″video/mp4″ codecs=″avc1.4D401F″
amiDisplayModel=”3” amiAttenuationUseIdc=”1” >
      <BaseURL>attenuation_maps/</BaseURL>
      <SegmentTemplate timescale=″90000″ media=″$id$/$Time$.mp4v″>
        <SegmentTimeline>
          <S t=″0″ d=″180180″ r=″432″/>
        </SegmentTimeline>
      </SegmentTemplate>
      <Representation id=″ami0″ bandwidth=″1000″ associationId=″v0″
        associationType=″gmam″ amiEnergyReductionRate=”20”
amiVideoQualityMetric=”PSNR” amiVideoQualityReduction=”5”
amiMapApproximationModel=”0”/>
    </AdaptationSet>
    <AdaptationSet id=″ami″ group=’10’ mimeType=″video/mp4″ codecs=″avc1.4D401F″
amiDisplayModel=”3” amiAttenuationUseIdc=”1” >
      <BaseURL>attenuation_maps/</BaseURL>
      <SegmentTemplate timescale=″90000″ media=″$id$/$Time$.mp4v″>
        <SegmentTimeline>
          <S t=″0″ d=″180180″ r=″432″/>
        </SegmentTimeline>
      </SegmentTemplate>
      <Representation id=″ami1″ bandwidth=″1000″ associationId=″v0″
        associationType=″gmam″ amiEnergyReductionRate=”10”
amiVideoQualityMetric=”PSNR” amiVideoQualityReduction=”5”
amiMapApproximationModel=”0”/>
    </AdaptationSet>
  </Period>
</MPD>
```

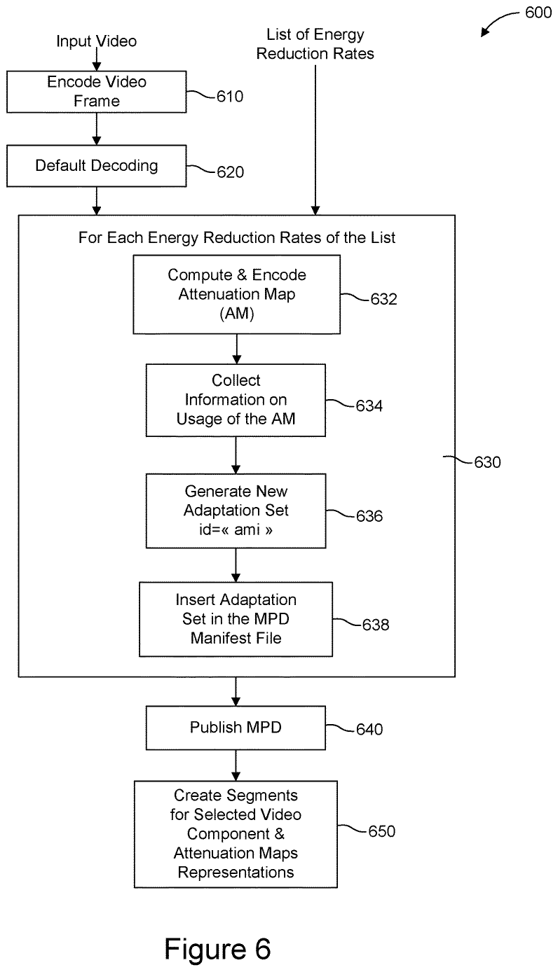

FIG. 6 illustrates an example of process for creating a DASH content comprising Attenuation Maps according to an embodiment. This process 600 is implemented by an energy-aware DASH server as represented in FIG. 4 and comprising a DASH media presentation preparation module 410, an Encoding module 412, and a Map Generation module 414. The process 600 is performed for a subset of the video and for a single representation. It is repeated to handle the whole video with different variations in terms of resolution, bitrate, etc. The number of representations and Attenuation Maps is function of the knowledge of the ecosystem by the DASH server, including network capabilities, type of client, type of content, minimal quality level, etc. In step 610, the Encoding module 412 encodes an image of the subset of the input video and performs its decoding in step 620.

The step 630 is then iterated on a list of energy reduction rates. In an extreme case, the list contains only a single element. In step 632, for the selected energy reduction rate, the Map Generation module 414 generates a corresponding Attenuation Map for an image of the decoded video. The Attenuation Map is designed so that, when applied to an input image, it produces a modified image that requires less energy for display than the input image. One simple implementation is to scale down the luminance according to a selected energy reduction rate, for each pixel of the image. Attenuation Maps are pixel wise Attenuation Maps, meaning that in principle their resolution is identical to the resolution of the image. However, when the Attenuation Map has a smoothness characteristics, it is possible to use a downscaled version to reduce the size of the Attenuation Map. More complex implementation takes other parameters into account such as the similarity between the modified image and the input image, or the contrast sensitivity function of the human vision, or a smoothness characteristic that allows to downscale the Attenuation Map without introducing heavy artefacts when upscaling it on the decoder side, etc. An Attenuation Map may also be generated for example using a deep learning network that may result into an Attenuation Map that is smooth and flexible, in other words, that can be downscaled/upscaled with regards to the resolution and that can be interpolated to obtain an attenuation for another target energy reduction rate, while keeping a satisfying quality of experience when displaying the energy-reduced image. In at least one embodiment, instead of generating Attenuation Maps, the server may also obtain pre-determined Attenuation Maps for the content for example from a database of Attenuation Maps, the computation step having already been done earlier.

The generated Attenuation Map is then encoded. In step 634, the DASH media presentation preparation module 410 collects information on the usage of the Attenuation Map. This information comprises for example its expected energy reduction and the corresponding expected quality. A corresponding “ami” adaptation set is generated in step 636. In step 638, the “ami” adaptation set is inserted in the MPD manifest file, for example using the semantic described in tables 1 to 10. The steps 632, 634, 636, 638 are then iterated for the other values of energy reduction rates of the list. In step 640, the MPD manifest file is then published so that a DASH client can access it. In step 650, segments of the video component and the Attenuation Maps are created.

As a result, when the DASH client requests to display a video for example according to a selected representation and the corresponding energy reduction rate, segments of the appropriate encoded video and associated Attenuation Map representation are transmitted by the DASH segment delivery function to the DASH client.

In an embodiment, the computation of the Attenuation Map representation and the collection of the associated metadata is realized outside the encoder. The input Video used to compute the Attenuation Map representation is the original video and not the output video from the internal decoder of the encoder. The associated metadata are transmitted to the DASH Media Presentation preparation entity to create the “ami” Adaptation Set and insert them in the MPD manifest file. Attenuation Map representation corresponding to the picture is computed and encoded by the Attenuation Map Computing entity. The original video is encoded by the encoder and the synchronized bitstream outputs of the two processes are transmitted to the Dash segment delivery function.

In an embodiment, a set of new attributes for the use of the Attenuation Map representations are added in the “ami” Adaptation Set or the representation of association Type=“amit” elements (see Tables 9 and 10).

In an embodiment, several Attenuation Map representations with different reduction rates can be computed and the “ami” Adaptation Set contains several Attenuation Map representations for the same Video component representation.

In an embodiment, one or more Attenuation Map representations are computed with different reduction rates and the attribute @amiMapApproximationModel is added in the representation elements of the “ami” Adaptation Set in order to allow the DASH Client to generate new Attenuation Map representation from the ones it received from the DASH Server. This embodiment allows to reduce the use of the network bandwidth. For example, two Attenuation Map representations with energy reduction rates R₁ and R₂ are provided/encoded. This will allow at the decoder side to interpolate for any other reduction rate R such as R₁<R<R₂.

In an embodiment, attributes @amiBoxXstart, @amiBoxYstart, @amiBoxWidth, @amiBoxHeight are added in the Representation element of associationType=“amit” to indicate the part of the picture on which the Attenuation Map representation should be applied. Instead of transmitting an Attenuation Map representation with the same size of the Video representation, only the area of the picture which allows a significative display energy consumption reduction is given. This can also be seen as a representation alternative selection for the DASH client between a partial or a full Attenuation Map representation. In that case, the DASH server can create the two Attenuation Map representations, one with attributes @amiBoxXstart, @amiBoxYstart, @amiBoxWidth, @amiBoxHeight and one without.

The Attenuation Map representations can be at different granularity levels of the video media component: at picture level, part of picture (slices, tiles, sub-pictures) level or at GOP or scene level. To handle these different levels, the “ami” Adaptation Set and the attached Attenuation Map representation of AssociationType=“amit” elements may be updated accordingly to reflect changes in the presentation over time. In an embodiment, the update can be performed by, in case of MPD@type=static, the definition of different @period in the MPD with different “ami” Adaptation Sets and attached Attenuation Map representations of Association Type=“amit” or in case of MPD@type=“dynamic”, an update of one unique “ami” Adaptation Set.

FIG. 7 illustrates an example of process for using Attenuation Map representations according to an embodiment. Such process 700 is implemented by an energy-aware DASH client such as the display device 100 of FIG. 1. This process is for example implemented by a processor of such device. This process is for example initiated by the user that request streaming of a multimedia content.

Prior to this process, a target reduction rate has been selected. This selection may be done using different techniques. In an embodiment, the target reduction rate may be selected though a manual user operation by setting a numeric value for the target. For example, a slider may be displayed on the screen and controlled by the user to adjust a numerical value representing the target reduction rate. A numeric value may also be entered directly using digit keys on a keyboard.

In an embodiment, a list of potential target reduction rates may be displayed on the screen to allow the user to select one of the rates to become the target reduction rate. The list of rates is for example restricted to the list of @amiEnergyReductionRate parameters in the MDP manifest file of the selected multimedia content.

In an embodiment, the target reduction rate is selected though a configuration setting of the display device and obtained from the display device without requiring user intervention before displaying a multimedia content. Such configuration setting should preferably be under control of the user, for example through a dedicated user interface.

In an embodiment, the target reduction rate is selected according to the category of multimedia content and based on a user configuration. The category may correspond to a classification, for example allowing to differentiate movies, news, advertisements, talk shows, music shows, etc. A user would be able to select using a dedicated user interface the target reduction rate for each category.

In step 710, the DASH client requests a MPD manifest file. In step 715, after obtaining the MPD Manifest file, this file is processed to extract the necessary data to select the video component representation, the Attenuation Map representation(s), the parameters to configure the Decoding module, the Attenuation Maps post-processing module and the rendering modules. In step 720, the DASH client checks if the display model corresponding to the screen that will display the multimedia content is in the list of display models of the MPD. This is done in step 720 by comparing the display model (or type) information of the screen to the @amiDisplayModel parameter in the MPD.

In an example, the @amiDisplayModel parameter in the MPD is set to 1 to indicate that the Attenuation Map representation should be used on an emissive display. If there is no match in step 720, for example for a first DASH client with a non-emissive display, the process goes to step 725. The first DASH client requests and receives representation segments for the video, decodes the pictures of the video in step 730 and provides the picture to the screen for being displayed, in step 735. The expected energy reduction will not be available for this first DASH client.

When there is a match in step 720, for example for a second DASH client with a non-emissive display and @amiDisplayModel set to 1, then the second DASH client will be able to benefit from an energy reduction allowed by the embodiments and will display an energy-reduced version of the multimedia content therefore lowering its energy consumption. In this case, the second DASH client requests the Attenuation Map representation segment that corresponds to the selected target reduction rate, in step 740 and receives it. In step 745, the Attenuation Map representation is then decoded and optionally preprocessed in step 750, according to the parameters of the “ami” Adaptation Set. For example, the Attenuation Map representation will be subsampled to reduce the quantity of data to be encoded. In this case, an upscaling is performed on the attenuation so that its resolution corresponds to the resolution of the image to be displayed. Independently from the steps 740 to 750 (i.e., possibly at the same time or sequentially), the second DASH client requests the video component representation segment, in step 760 and receives it. In step 765, the picture of the video component representation segment is then decoded. In step 770, when both the Attenuation Map representation and corresponding picture have been decoded, the second DASH client combines them by applying the decoded Attenuation Map representation to the decoded picture. This combination is performed according to the parameters discussed above in tables 1 to 8. For example, the @amiAttenuationUseIdc parameter is used to determine if the Attenuation Map representation should be added to the decoded picture, subtracted from the decoded picture, or multiplied to the decoded picture. The @amiAttenuationCompIdc parameter is used to determine on which components the combination of the Attenuation Map representation with the decoded picture should be done, for example on luma only, on all RGB values, etc. After the combination is done, the picture is provided to the screen, in step 780, for being displayed. Compared to the display of the corresponding non-attenuated picture, the device will lower its energy consumption since it displays an energy-reduced version of the picture.

Additionally, in the example where none of the available Attenuation Map representations proposes the target energy reduction rate selected by the user, the device will select one of the available Attenuation Map representations and the step 750 will comprise an interpolation of the Attenuation Map representation values to obtain the selected target energy reduction rate. The selection is done by choosing for example the attenuation with closest reduction rate with regards to the selected target reduction rate. In the case where the selected target energy reduction rate is between two available target energy reduction rates, then the steps 740 and 745 will request, receive, and decode the Attenuation Map representations corresponding to these two reduction rates to be able to perform an interpolation between their values. For example, when the user selected a 30% reduction rate and the available Attenuation Map representations have reduction rates of 20% and 40%, then these two maps will be interpolated by simply taking the average values.

In an embodiment, the DASH client is not in an energy consumption reduction mode and therefore does not consider the “ami” Adaptation Set and the attached Attenuation Map representations. Only the video component representation segments are requested. In other words, for the process 700, it will only execute the steps 710, 715, 725, 730 and 735.

In an embodiment, the DASH client can decide to request multiple Attenuation Map representations with different reduction rates when it is able to execute the attribute @amiMapApproximationModel of the representation elements of the “ami” Adaptation Set element to generate new Attenuation Map representation with different reduction rates. This embodiment allows to reduce the use of the network bandwidth. For example, when two Attenuation Map representations with energy reduction rates R₁ and R₂ are available, the DASH client may generate a new Attenuation Map representation by interpolating the respective Attenuation Map representations for any other reduction rate R such as R₁<R<R₂.

In an embodiment, the DASH client only requests the Attenuation Map representations with @amiAttenuationUseIdc attribute it can deal with, i.e., it has not the capability to execute the process to apply the Attenuation Map representation to the decoded video. In an embodiment, the DASH client only requests the Attenuation Map representations with @amiPreprocessingTypeIdc attribute it can deal with, i.e., it has not the capability to execute the preprocessing method before applying the Attenuation Map representation to the decoded video. In an embodiment, the DASH client only requests the attenuation maps with an acceptable value (i.e., content provider expectation) of the @amiVideoQuality attribute. In an embodiment, the DASH client prioritizes Attenuation Map representations with attributes @amiBoxXstart, @amiBoxYstart, @amiBoxWidth, @amiBoxHeight instead of selecting the attenuation Map representation of the same size of the Video representation. The selection of these representations allows to reduce the use of the network bandwidth to transmit the Attenuation Map representation by using partial Attenuation Map representations and thus to reduce the display energy consumption.

In embodiments described above, the attenuation map parameters are directly carried by the MPD manifest file. In embodiments described below, attenuation maps and related parameters are carried as separate tracks in an ISOBMFF media container. The MPD manifest file comprises references to the separate tracks (i.e. representation element within the new Display Attenuation Map adaptation set element) but does not contain directly the parameters related to attenuation maps. In at least one embodiment, information is stored in an Attenuation Map track for example using a box syntax for the track. In at least one embodiment, the attributes related to attenuation maps are carried by the initialization segment of an Attenuation Map track (e.g.: element 350 of FIG. 3).

According to at least one embodiment, the “ami” adaptation set does not contain new attributes other than the ones specified in the ISO/IEC 23009-1 document to carry the information about the Attenuation Map. The attributes AdaptationSet@id, AdaptationSet@contentType, AdaptationSet@group, AdaptationSet@role, Representation@associationId and Representation@associationType are used to select an attenuation map (or several) and associate it (or them) to the original image. In such embodiment, a DASH server prepares a track file (to be inserted in a media container) that comprises the information related to the attenuation map (parameters as well as the attenuation map itself) and the track file is then referenced in the MPD manifest file. On the receiver side, rather than accessing directly the parameters related to the attenuation map from the MPD manifest file, a DASH client first obtains a reference of track file, accesses the referenced track file from the media container and extracts the attenuation map parameters from the referenced track file according to the track file format mentioned above.

Table 14 represents an example of MPD manifest file according to an embodiment where the attenuation map parameters are carried as separate tracks. This example uses two Adaptation Set of @id=ami, @group=‘10’, role@value=‘ami’ and mimetype=video/mp4 corresponding to the type of the Attenuation Map representations, two Attenuation Map representation of @id=“ami0” and @id=“amil” associated with the associated type=“amit” to the Video Component representation @id=“v0”.

```
TABLE 14
<?xml version=”1.0” encoding=”UTF-8”?>
<MPD
  xmlns:xsi=″http://www.w3.org/2001/XMLSchema-instance″
  xmlns=″urn:mpeg:DASH:schema:MPD:XXXX″
  xsi:schemaLocation=″urn:mpeg:DASH:schema:MPD:xxxx″
  type=″dynamic″
  minimumUpdatePeriod=″PT2S″
  timeShiftBufferDepth=″PT30M″
  availabilityStartTime=″2011-12-25T12:30:00″
  minBufferTime=″PT4S″
  profiles=″urn:mpeg:dash:profile:isoff-live:2011″>
  <BaseURL>http://cdn1.example.com/</BaseURL>
  <BaseURL>http://cdn2.example.com/</BaseURL>
  <Period>
    <!-- Video -->
    <AdaptationSet
      id=″video″
      mimeType=″video/mp4″
      codecs=″avc1.4D401F″
      frameRate=″30000/1001″
      segmentAlignment=″true″
      startWithSAP=″1″>
      <BaseURL>video/</BaseURL>
      <SegmentTemplate timescale=″90000″ media=″$Bandwidth$/$Time$.mp4v″>
        <SegmentTimeline>
          <S t=″0″ d=″180180″ r=″432″/>
        </SegmentTimeline>
      </SegmentTemplate>
      <Representation id=″v0″ width=″320″ height=″240″ bandwidth=″250000″/>
      <Representation id=″v1″ width=″640″ height=″480″ bandwidth=″500000″/>
      <Representation id=″v2″ width=″960″ height=″720″ bandwidth=″1000000″/>
    </AdaptationSet>
    <!-- English Audio -->
    <AdaptationSet mimeType=″audio/mp4″ codecs=″mp4a.0x40″ lang=″en″
segmentAlignment=″0″>
      <SegmentTemplate timescale=″48000″ media=″audio/en/$Time$.mp4a″>
        <SegmentTimeline>
          <S t=″0″ d=″96000″ r=″432″/>
        </SegmentTimeline>
      </SegmentTemplate>
      <Representation id=″a0″ bandwidth=″64000″ />
    </AdaptationSet>
    <!-- French Audio -->
    <AdaptationSet mimeType=″audio/mp4″ codecs=″mp4a.0x40″ lang=″fr″
segmentAlignment=″0″>
      <SegmentTemplate timescale=″48000″ media=″audio/fr/$Time$.mp4a″>
        <SegmentTimeline>
          <S t=″0″ d=″96000″ r=″432″/>
        </SegmentTimeline>
      </SegmentTemplate>
      <Representation id=″a0″ bandwidth=″64000″ />
    </AdaptationSet>
<!--AdaptationSet carrying Attenuation Maps for display energy reduction for
Video -->
    <AdaptationSet id=″ami″ group=”10” mimeType=″video/mp4″ codecs=″avc1.4D401F″
>
      <BaseURL>attenuation_maps/</BaseURL>
      <Role schemeIdUri=″urn:mpeg:dash:role:2011″ value=″ami″/>
      <SegmentTemplate timescale=″90000″ media=″$id$/$Time$.mp4v″>
        <SegmentTimeline>
          <S t=″0″ d=″180180″ r=″432″/>
        </SegmentTimeline>
      </SegmentTemplate>
      <Representation id=″ami0″ bandwidth=″1000″ associationId=″v0″
        associationType=″amit″ />
    </AdaptationSet>
    <AdaptationSet id=″ami″ group=”10” mimeType=″video/mp4″ codecs=″avc1.4D401F”>
      <BaseURL>attenuation_maps/</BaseURL>
      <Role schemeIdUri=″urn:mpeg:dash:role:2011″ value=″ami″/>
      <SegmentTemplate timescale=″90000″ media=″$id$/$Time$.mp4v″>
        <SegmentTimeline>
          <S t=″0″ d=″180180″ r=″432″/>
        </SegmentTimeline>
      </SegmentTemplate>
      <Representation id=″ami1″ bandwidth=″1000″ associationId=″v0″
        associationType=″amit″ />
    </AdaptationSet>
  </Period>
</MPD>
```

As explained above, in such embodiment, the MPD manifest file does not comprise any information related to the attenuation map parameters. The DASH client has to parse the tracks referenced in the MPD manifest file to obtain these parameters.

In such embodiment where the attenuation map parameters are carried as tracks, with reference to the energy-aware DASH server of FIG. 4, the attenuation map encoded bitstream takes the form of a separate track, for example named display attenuation map track and comprises the attenuation map data as computed by the Map Generation module 414 and the related parameters for example as defined in tables 1 to 9. With reference to the content creation process of FIG. 6, a step 635 is added to the process and comprises the generation of a display attenuation map box to be inserted in the attenuation map track, and more particularly to the initialization segment of the track (first element of segment 350 of FIG. 3). This box comprises the parameters related to the attenuation map, for example as defined in tables 1 to 9. The display attenuation map box may have the syntax illustrated in table 15.

TABLE 15

```
aligned(8) class AttenuationMapInformationBox( ) extends
FullBox(‘amid’) {
  bit(3) reserved = 0;
  unsigned int(1) ami_preprocessing_info_present_flag;
  unsigned int(1) ami_approx_model_present_flag;
  unsigned int(1) ami_window_info_present_flag;
  unsigned int(1) ami_video_quality_info_present_flag;
  unsigned int(5) ami_energy_reduction_rate;
  unsigned int(4) ami_display_model;
  unsigned int(4) ami_attenuation_use_idc;
  unsigned int(4) ami_attenuation_component_idc;
  if (ami_preprocessing_info_present) {
    AMIPreprocessingInfo( );
  }
  if (ami_approx_model_present_flag) {
    AMIApproximationModel( );
  }
  if (ami_window_info_present_flag) {
    AMIWindowInfo( );
  }
  if (ami_video_quality_info_present_flag) {
    AMIVideoQualityInfo( );
  }
}
```

The ami_processing_info_present_flag, ami_approx_model_present_flag, ami_window_info_present_flag, and ami_video_quality_info_present_flag flags indicate whether the corresponding information is present. Value 1 indicates that the box contains the corresponding information. The default value for this field is 0. The AttenuationMapInformationBox may include one or more of the data structures illustrated in table 16. The semantics of each data structure is as described above in tables 1 to 9.

TABLE 16

```
class AMIApproximationModel( ) {
  unsigned int(4) ami_map_approx_model;
}
aligned(8) class AMIWindowInfo( ) {
  unsigned int(8) ami_window_x;
  unsigned int(8) ami_window_y;
  unsigned int(8) ami_window_width;
  unsigned int(8) ami_window_height;
}
class AMIVideoQualityInfo( ) {
  unsigned int(3) ami_quality_metric;
  unsigned int(8) ami_quality_reduction;
}
class AMIPreprocessingInfo( ) {
  unsigned int(2) ami_preprocessing_type;
  unsigned int(8) ami_max_value;
  unsigned int(8) ami_preprocessing_scale;
}
```

In such embodiment where the attenuation map parameters are carried as separate tracks, with reference to the energy-aware DASH client of FIG. 5, the energy reduction metadata are extracted from the initialization segment (first element of segment 350 of FIG. 3) instead of being extracted from the MDP. In such embodiment, with reference to the process for using attenuation maps of FIG. 7, a step 717 is added. In this step, the processor requests the initialization segment (first element of segment 350 of FIG. 3) of an attenuation map track and retrieves the attenuation map parameters. As seen above, this initialization segment is for example based on the syntax of tables 15, 16 and 1 to 9. In the case where the attenuation map parameters of the track do not correspond to the expected strategy and/or context (e.g.: different reduction rate, incorrect display model), the processor requests the initialization segment of another attenuation map track listed in the MPD manifest file and retrieves the corresponding parameters. When the parameters correspond to the expected strategy, the process continues as described in FIG. 7 based on the attenuation map parameters extracted from the box of the initialization segment of the selected track and based on the attenuation map of the same track.

In general, another aspect is related to a bitstream or signal formatted to include syntax elements and picture information, wherein the syntax elements are produced, and the picture information is encoded by processing based on any one or more of the examples of embodiments of methods in accordance with the present disclosure.

Although parts of the description refer to images, the embodiments are not restricted to images and apply to any type of visual media content such as conventional (2D) videos, stereoscopic (3D) images or videos, 360° immersive images or video, based on the same principles as described above but iterated temporally and/or spatially.

In general, one or more other examples of embodiments can also provide a computer readable storage medium, e.g., a non-volatile computer readable storage medium, having stored thereon instructions for encoding or decoding picture information such as video data according to the methods or the apparatus described herein. One or more embodiments can also provide a computer readable storage medium having stored thereon a bitstream generated according to methods or apparatus described herein. One or more embodiments can also provide methods and apparatus for transmitting or receiving a bitstream or signal generated according to methods or apparatus described herein.

Many of the examples of embodiments described herein are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the embodiments, features, etc. can be combined and interchanged with others described in earlier filings as well.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

In general, the examples of embodiments, implementations, features, etc., described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. One or more examples of methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users. Also, use of the term “processor” herein is intended to broadly encompass various configurations of one processor or more than one processor.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Various embodiments are described herein. Features of these embodiments can be provided alone or in any combination, across various claim categories and types.

1. A method for reducing energy consumption during an adaptive video streaming session comprising:
obtaining, from a manifest file associated with the adaptive video streaming session, information identifying one or more attenuation map representations, the information comprising one or more attributes defining an attenuation map display model, an attenuation use type, and an attenuation combination type, and information representative of the presence of an attenuation map track;
obtaining an initialization segment of the attenuation map track comprising the one or more attenuation map representation;
selecting one or more attenuation map representations of the one or more attenuation map representation based on a target energy reduction rate;
requesting temporal segments of a video representation and temporal segments of the one or more attenuation map representations;
decoding picture from obtained temporal segments of the video representation
decoding the one or more attenuation map representations;
combining the decoded one or more attenuation representation with the decoded picture in accordance with the attenuation map display model, the attenuation use type, and the attenuation combination type to obtain an attenuated picture; and
providing the attenuated picture.

2. (canceled)

3. The method of claim 1, wherein the information identifying one or more attenuation map representations further comprises information representative of a type of combination between the attenuation map representation and the video representation, the type of combination being selected amongst a set comprising addition, subtraction and multiplication.

4. The method of claim 1, wherein the information identifying one or more attenuation map representations further comprises information representative of a component selection for the combination between the one or more attenuation map representations and the video representation, the type of combination being selected amongst a set comprising applying a component of the one or more attenuation map representation to luma components of the video representation, applying a first component of the one or more attenuation map representation to luma components of the video representation and a second component of the one or more attenuation map representation to chroma components of the video representation, applying a component of the one or more attenuation map representation to luma and chroma components of the video representation, applying a component of the one or more attenuation map representation to three RGB components of the video representation, applying three components of the one or more attenuation map representation respectively to luma components and chroma components of the video representation, and applying three components of the one or more attenuation map representation respectively to three RGB components of the video representation.

5. The method of claim 1, wherein the information identifying one or more attenuation map representations further comprises information representative of a type of display selected amongst a set comprising emissive and non-emissive displays.

6. The method of claim 1, further comprising, in case the selected energy reduction rate is not comprised in the information identifying one or more attenuation map representations, selecting an attenuation map representation whose energy reduction rate is the closest to the selected energy reduction rate and wherein the attenuation map representation is extrapolated accordingly.

7. The method of claim 1, further comprising, in case the selected energy reduction rate is not comprised in the information identifying one or more attenuation map representations, selecting a couple of attenuation map representations whose energy reduction rates are respectively higher and lower than the selected energy reduction rate and wherein the attenuation map representation is interpolated accordingly.

8. The method of claim 6, wherein the information identifying one or more attenuation map representations further comprises information representative of a type of interpolation.

9. The method of claim 8, wherein, the type of interpolation is selected amongst a set comprising at least a linear scaling, a Lanczos interpolation, or a bicubic interpolation.

10. The method of claim 1, wherein the size of the one or more attenuation map representation is smaller than the size of the decoded picture, the method further comprising upsampling the Attenuation Map representation to the size of the decoded picture before combining them.

11. The method of claim 1, wherein the manifest file, the segments and the requests are based on the MPEG-DASH specification.

12. (canceled)

13. A method comprising:
encoding a video from an obtained visual content;
decoding the encoded video;
for a one or more target energy reduction rates,
generating an attenuation map representation based on the decoded video;
generating an attenuation map track comprising parameters related to the attenuation map;
generating adaptation set information signaling the attenuation map track; and
generating a manifest file representative of the obtained visual content comprising information related to the encoded video, representative of the use of one or more attenuation maps and representative of the attenuation map track.

14-16. (canceled)

17. The method of claim 13, further comprising publishing the manifest file.

18. The method of claim 17, further comprising, in response to a first request from a client device, provide the requested manifest file.

19. The method of claim 18, further comprising, in response to a second request from a client device, provide the requested temporal segment of the video and the one or more attenuation map representation.

20. A device for reducing energy consumption during an adaptive video streaming session comprising a processor configured to:
obtain, from a manifest file associated with the adaptive video streaming session, information identifying one or more attenuation map representations, the information comprising one or more attributes defining an attenuation map display model, an attenuation use type, and an attenuation combination type, and information representative of the presence of an attenuation map track;
obtain an initialization segment of the attenuation map track comprising the one or more attenuation map representation;
select one or more attenuation map representations of the one or more attenuation map representation based on a target energy reduction rate;
request temporal segments of a video representation and temporal segments of the one or more attenuation map representations;
decode picture from obtained temporal segments of the video representation
decode the one or more attenuation map representations;
combine the decoded one or more attenuation representation with the decoded picture in accordance with the attenuation map display model, the attenuation use type, and the attenuation combination type to obtain an attenuated picture; and
provide the attenuated picture.

21. (canceled)

22. A non-transitory computer readable medium storing executable program instructions to cause a computer executing the instructions to perform a method according to claim 1.

23. A non-transitory computer readable medium storing executable program instructions to cause a computer executing the instructions to perform a method according to claim 13.

24. The method of claim 7, wherein the information identifying one or more attenuation map representations further comprises information representative of a type of interpolation.

25. The method of claim 24, wherein, the type of interpolation is selected amongst a set comprising at least a linear scaling, a Lanczos interpolation, or a bicubic interpolation.
